(19) United States
(12) Patent Application Publication
(10) Pub. No.: US 2016/0116296 A1
(43) Pub. Date: Apr. 28, 2016

(54) PROVIDING INSTANT ROUTING OPTIONS

(71) Applicant: Urban Engines, Inc., Los Altos, CA (US)

(72) Inventors: Giao Nguyen, Sacramento, CA (US); Winston W. Hsu, Sunnyvale, CA (US); Narayanan Shivakumar, Los Altos, CA (US)

(21) Appl. No.: 14/921,854

(22) Filed: Oct. 23, 2015

Related U.S. Application Data
(60) Provisional application No. 62/069,273, filed on Oct. 27, 2014.

(51) Int. Cl. G01C 21/34; G01C 21/36

(52) U.S. Cl. CPC G01C 21/3423; G01C 21/3605; G01C 21/3626; G01C 21/3676

(57) ABSTRACT

Routing options are provided to a user automatically and in real-time as the user pans over an interactive map. In operation, to provide the routing options in real-time, a map server receives a selection of a focal point overlaid on an interactive map displayed to a user. The location of the focal point relative to the display of the interactive map remains static such that, as the user pans the map, the location of the focal point remains the same but the corresponding location represented by the map changes. As the panning interaction is ongoing, the map server determines the new location corresponding to the focal point and determines routing options from an origin location to the new location. The determined routing options may be displayed to the user.

### CROSS-REFERENCE TO RELATED APPLICATIONS

This application claims the benefit of U.S. Provisional Application No. 62/069,273, filed on Oct. 27, 2014, which is hereby incorporated by reference in its entirety.

### BACKGROUND

1. Field of Art

The disclosure generally relates to the field of electronic maps, and specifically to provide instant routing options to users of electronic maps.

2. Description of the Related Art

As the technologies of Geographic Information Systems (GIS) develop rapidly, electronic maps have been more and more widely used in various applications. Users use electronic maps to guide their trips. In addition, the electronic maps have become interactive, such as allowing users to zoom in or zoom out, sometimes by replacing one map with another of a different scale, centered where possible on the same point. Furthermore, some electronic maps have route-planning function and advice facilities by monitoring the user's position with the help of satellites.

However, current solutions for electronic maps require affirmative actions by a user when providing routing options. The user manually inputs at least an endpoint location and, in response to the input, routing options are presented to the user. In the event that the endpoint location changes, the user is required to again manually input the endpoint location to receive new routing options. This is inconvenient when a user is exploring an electronic map to determine the optimal routing and transportation options for herself.

### BRIEF DESCRIPTION OF THE DRAWINGS

FIG. 1 is a high-level block diagram of an example computing environment for rendering a stack of maps according to one embodiment.

FIG. 2 illustrates different components of the digital map server according to one embodiment.

FIG. 3 is a flowchart illustrating an example method for providing routing options responsive to map panning interactions according to one embodiment.

FIGS. 4A-5B are example graphical representations for user interfaces related to providing routing options to a user according to one embodiment.

FIG. 6 is a flowchart illustrating an example method for simultaneously providing routing options for multiple endpoint locations according to one embodiment.

FIG. 7 is a block diagram illustrating components of an example machine able to read instructions from a machine-readable medium and execute them in a processor (or controller) for acting as a client device and/or server according to one embodiment.

### DETAILED DESCRIPTION

The disclosed embodiments have advantages and features, which will be more readily apparent from the detailed description, and the accompanying figures (or drawings).

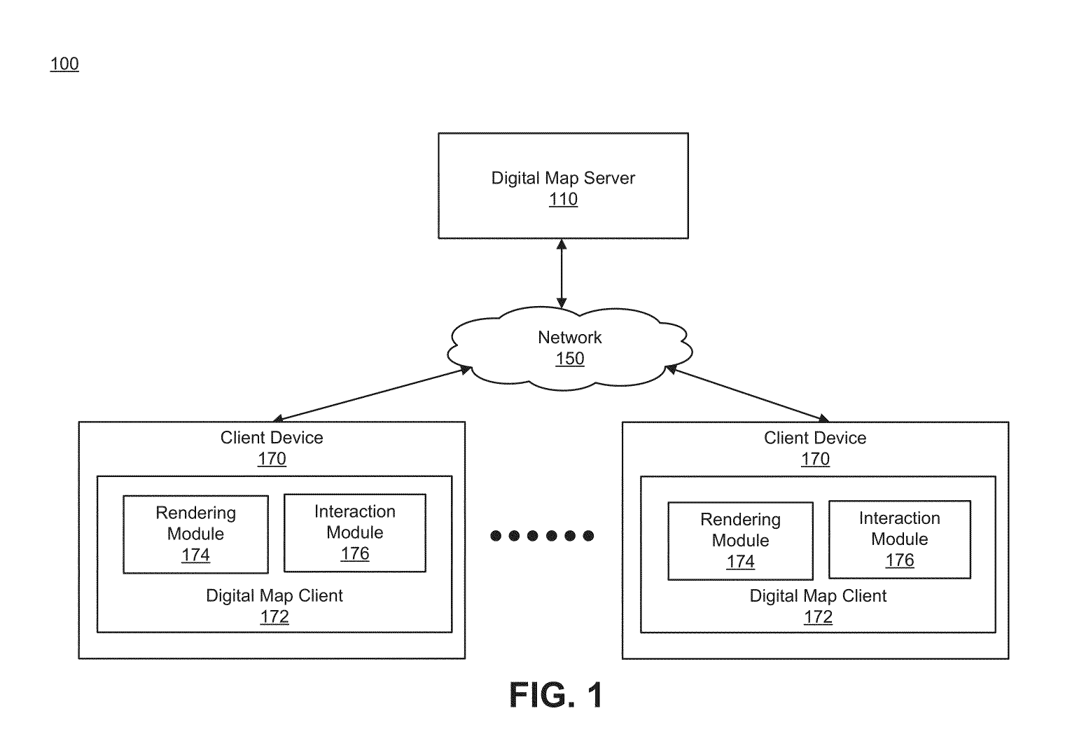

The FIGS. 1-6 and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Example Computing Environment

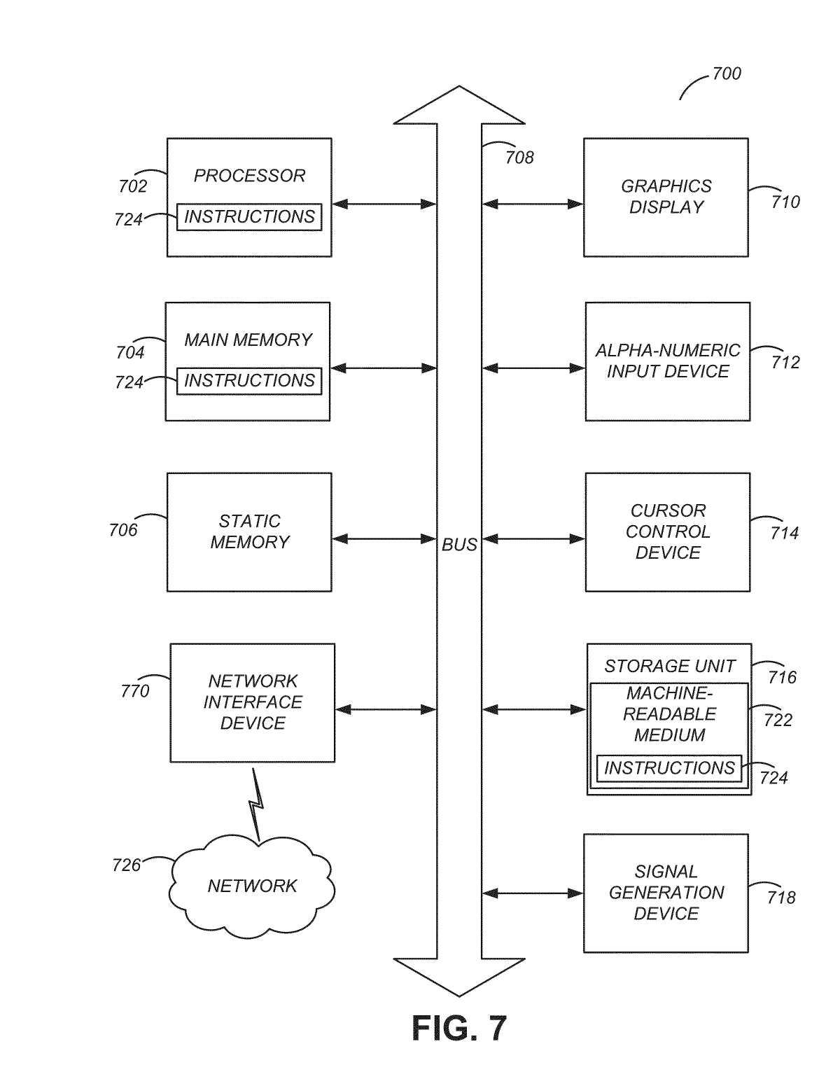

Turning now to FIG. 1, it shows an example computing environment 100 for rendering a stack of maps according to one embodiment. The computing environment 100 includes one or more digital map servers (generally, map server) 110 and one or more client devices (generally, client device) 170 connected by a network 150. Only one map server 110 and two client devices 170 are shown in FIG. 1 in order to simplify and clarify the description. Alternate or additional embodiments of the computing environment 100 can have multiple servers 110 and more than two client devices 170 connected to the network 150. Likewise, the functions performed by the various entities of FIG. 1 may differ in different embodiments. An example computing configuration of the server devices (or server) 110 and client devices (or clients) 170 is described in FIG. 7.

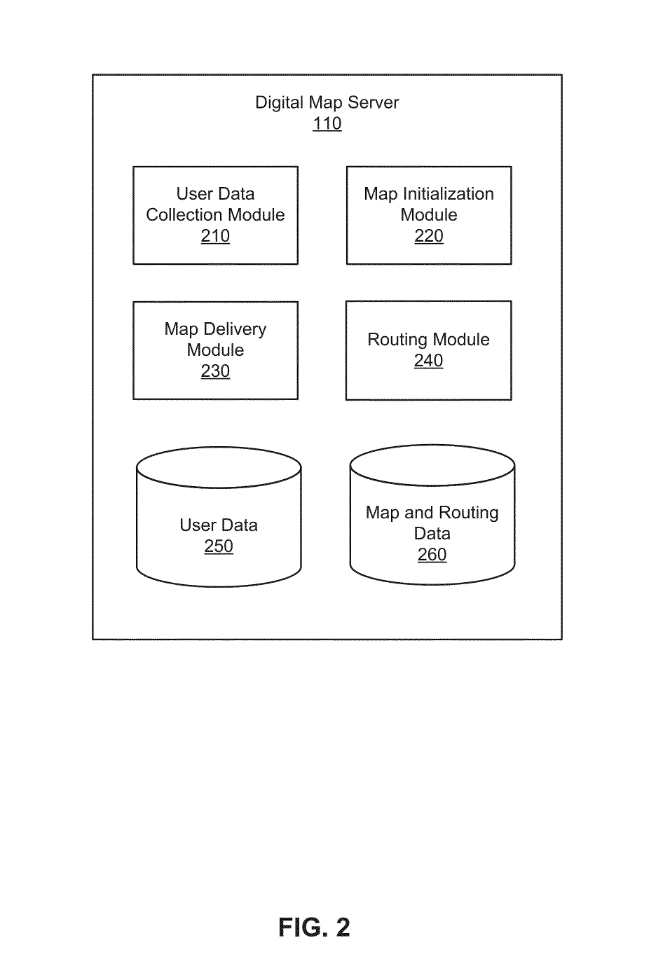

The map server 110 is configured to store and provide map data associated with digital maps to the digital map clients 172 executing in the client devices 170. A digital map is a collection of map data that is compiled and formatted into a virtual image of a physical area. The map server 110 stores map data representing different physical areas. Upon receiving a request from a map client 172, the map server 110 transmits a portion of the map data to the map client 172 for presentation to a user in a user interface. The mechanisms by which the map server 110 maintains and provides map data are described in greater detail below in conjunction with FIG. 2.

A client device 170 is an electronic device used by a user to perform functions such as interacting with navigation maps, consuming digital content, executing software applications, browsing websites hosted by web servers on the network 150, downloading files, and interacting with the map server 110. For example, the client device 170 may be a dedicated e-Reader, a smartphone, or a tablet, laptop, notebook, or desktop computer configured similar to a computing system described with FIG. 7.

The client device 170 also includes and/or interfaces with a display device on which the user may view visualizations such as graphical user interfaces (GUIs) showing digital maps. In addition, the client device 170 provides a visual user interface (UI) that is rendered on a screen (or display). The screen may be touch sensitive and responsive to gestures. If the screen is not touch sensitive, the user interface also may include on-screen buttons. The user may interact directly with the rendered user interface (e.g., using gestures) and/or the rendered buttons. The rendered user interface provides an interface for the user to interact with the client device 170 and perform functions. Examples of functions include selecting between maps, manipulating on elements of maps, inputting a destination, selecting a destination, zooming in and/or out the maps, and any other possible interactions.

Each of the client devices 170 includes a digital map client 172 (also referred to as a “map client 172”). The map client 172 is a software application (or program) that executes on the client device 170 and enables a user of the client device 170 to access map data and other related information provided by the map server 110. The map client 172 may be a standalone software application (e.g., a mobile application executing on a mobile device) or may be a web browser. The map client 172 includes a rendering module 174 and an interaction module 176. In other embodiments of the map client 170 includes different and/or additional components. In addition, the functions may be distributed among the components in a different manner than described herein.

The rendering module 176 is configured to receive map data from the map server 110 and generate a visualization of the map data for presentation in a user interface. In operation, the rendering module 176 is configured to generate an interactive map with which a user may interact via different types of interactions (e.g., pan, zoom, etc.). In one embodiment, the interactive map is the map immediately visible within the user interface on the client 170. The interactive map also is dynamic so locational information captured through the device can subsequently be illustrated within the user interface of the device. The interactive map also may illustrate a route from an origin location to an endpoint location or vice versa. The origin and endpoint locations may be selected by a user or may be automatically determined based on previously collected about the user (e.g., meeting location retrieved from the user's calendar).

In some embodiments, the rendering module 176 is additionally configured to generate one or more dynamic maps that are presented in the user interface concurrently with the interactive map. The dynamic maps, however, are collapsed (or stacked on top of each other) such that only a portion of the dynamic maps is visible. A dynamic map may be a screen shot (or rendered image) of a map corresponding to a particular location and its surrounding area. The amount of area displayed within the screen shot can be predefined by the user, e.g., a radius corresponding to a predefined distance from the location that is the center point of the map. A collapsed dynamic map is not “interactive” due to the map itself not being fully viewable within the user interface on the client device. However, the information within a collapsed dynamic map is updated as the device updates location related information (e.g., current global positioning system (GPS) coordinates, cell phone tower location or WiFi information). In addition, a portion of the collapsed dynamic map is selectable so that in response to selection of the selectable area, that map becomes the new interactive map and the prior interactive map is removed from the user interface to be either discarded or returned to the collapsed stack of maps.

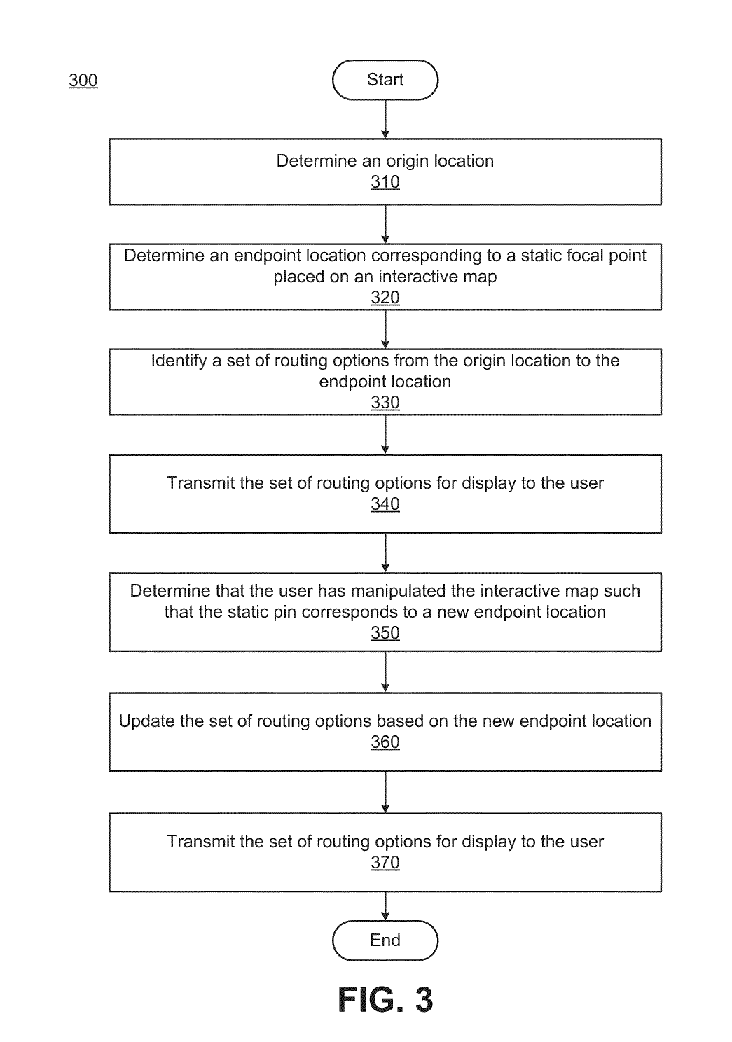

The interaction module 176 is configured to identify one or more interactions by a user of the map client 172 on an interactive map or the dynamic maps. These interactions may be of different types including selecting a particular point on the interactive map (for example, by dropping a pin), selecting a collapsed dynamic map, panning and zooming the interactive map, etc. The interaction module 176 is configured such that the identification of certain interaction types results in requests being transmitted to the digital map server 110 for supplementary map data or routing data. For example, selecting a collapsed dynamic map converts the map into an interactive map and, therefore, the interaction module 176 transmits a request for additional map data associated with the new interactive map to the map server 110. A particular set of interactions captured by the interaction module 176 involves identifying that the user has selected a particular location on the interactive map and has subsequently panned the map. This set of interactions and the subsequent operations by the interaction module 176 and the map server 110 are discussed in greater detail below in conjunction with FIG. 3.

The network 150, which can be wired, wireless, or a combination thereof, enables communications among the map server 110 and the client devices 170 and can comprise the Internet. In one embodiment, the network 150 uses standard communications technologies and/or protocols. In another embodiment, the entities can use custom and/or dedicated data communications technologies instead of, or in addition to, the ones described above.

### Digital Map Server Functions

FIG. 2 illustrates different components of the digital map server 110 according to one embodiment. As shown, the map server 110 includes a user data collection module 210, a map module 220, a routing module 240, a map update module 240, a user data store 250, and a map and routing data store 260. Other embodiments of the map server 110 may include different and/or additional components. In addition, the functions may be distributed among the components 110 and 172 in a different manner than described herein. For example, the map initialization module 220, the map update module 240, and/or the routing module 240 may be completely or partly included in the map client 172. In addition, it is noted that the modules may be configured as computer program code (or software) comprised of instructions storable in a storage unit and executable by one or more processors.

The user data collection module 210 is configured to collect data associated with users of the digital map clients 172 for storage in the user data store 250. In some embodiments, the data may be collected via an input mechanism provided by the map client 172. In alternate embodiments, the data may be collected via a combination of the map client 172 and other third party data sources. The user data associated with a given user may include account settings, such as name, address, routing preferences, visual preferences, etc. The user data may additionally describe one or more locations that the user previously reviewed or visited. For example, the user data describes a location (e.g., home, a supermarket, an entertainment place, an attraction, a school, a working place, etc.) that the user has selected as a predefined, e.g., favorite, location. Further, the user data may describe a context of the user. For example, the user data may describe a current location of the user detected by Global Positioning System (GPS) equipment, or other type of sensor included in the client device 170. Alternatively, the user data may include recommended sets or popular sets of destinations that are either pre-loaded or that the user has affirmatively selected, e.g., top tourist spots, and most popular restaurants. Furthermore, the user data can describe one or more locations favored by the user. The user data collection module 210 stores the data associated with different users in the user data store 250. The user data store 250 may be a database or any other storage mechanism that is configured for storage and retrieval of data.

The map initialization module 220 (also referred to as the “initialization module 220”) is configured to generate map data based on which interactive and dynamic maps may be rendered by the map clients 172. In one embodiment, the initialization module 220 processes the user data stored in the user data store 250 and the other type of data to generate map data corresponding to program code for rendering one or more maps on the user device. For example, based on a selection of a predefined, e.g., “favorite,” location, the initialization module 220 generates map data to render an interactive map and one or more dynamic maps that correspond with the location that the user selected as favorite. In one example embodiment, the map data for a map includes program code to provide for a rendering of a map on a user interface on the user device. In addition, there can be program code to render a zoom level for the map and/or code to render center coordinates of the map relative to a defined area within the map. The map data for a map may additionally include other information necessary for rendering the map on the client device 170. For example, the map data for a map describing a favorite location of the user may include an estimated time and distance from the favorite location to the current location of the user.

In one embodiment, the initialization module 220 determines map data to provide for rendering a map that corresponds with a screen captured map. For example, the map may be composed of a “screen shot” (e.g., program code for a user device to render or generate a display the map) of a location that was just entered, selected or pre-defined. In one embodiment, the screen shot map related to a location may be static in terms of visual appearance, but also is dynamic relative to data displayed within it. As data, e.g., updated GPS coordinates, is captured by a client device, e.g., 170, the screen shot map may be updated accordingly. For example, a wider range of the map may be displayed or there may be a zoom around the area of interest. This will render an update screen shot. Whether the screen shot map is re-rendered with a new screen shot map or not, the data within it may be updated, e.g., distance to a location of interest in the map relative to current coordinate of the client device 170. Hence, even though the map is not immediately visible on the user interface of the client device, the instructions corresponding to rendering of the map and/or data within it can be updated.

Accordingly, these maps below the interactive map also can be referred as to as “dynamic” (or “collapsed” or “stacked”) maps. As for the map that is within the field of view of the user interface, that also is rendered as a dynamic map, but also is an interactive map as the user is able to interact with that map when visible within the user interface. The initialization module 220 also may determine how the overall stack of maps corresponding to the map data for displaying multiple dynamic maps, is to be visually displayed. For example, it can provide for display the stack of maps as being collapsed at the edge of a user interface on the user interface within the screen of the client device 170.

In addition to a dynamic map, the initialization module 220 also generates map data for rendering an interactive map to the user. The interactive map includes live data that a user may interact with on the client device 170. For example, the interactive map can update as the user moves. The interactive map is interactive in that it can be manipulated, e.g., panned, zoom in, and zoom out, by a user. The interactive map also shows the current location of the user. In one embodiment, the interactive map may be rendered based on selection of previously stored locations, such as home, a work place, a shop, a grocery store, etc. The initialization module 220 may determine the map data for displaying the interactive map as the top most one in the stack (e.g., a stack is similar to a stack of cards) of maps. In other words, the interactive map is displayed on top of any dynamic maps in the stack so that the user can interact with the interactive map conveniently. Accordingly, the location described by the interactive map may be referred to as the “location in focus,” which in one example embodiment can be centered within a user interface.

In one embodiment, the initialization module 220 determines the map data for rendering an interactive map about a location and dynamic maps about other locations based on a preset rule. For example, the rule can be automatically determined based on GPS location or system rules or configuration (e.g., location name and pin points data pre-determined relative to map) and/or (b) manually determined by the user (e.g., only show certain data such as all gas stations around point of interest) and/or a third party that may offer predefined “points of interests” to load into the app (e.g., corresponding to advertisement offerings for a place of business within the map area). For example, based on the predefined (or preset) rule, the initialization module 220 determines the current location of the user as the location in focus and generates map data for rendering an interactive map about the current location, while rendering multiple dynamic maps about other locations (e.g., the user's favorite locations other than the current location). Alternatively, a preset rule may specify the home of the user is always the location in focus. Accordingly, the initialization module 220 generates map data for rendering an interactive map about the home of the user, while rendering multiple dynamic maps about other identified, predefined, or selected locations as defined by the user and potentially stored by the user.

The map data generated by the initialization module 220 can be referred to as “map data at setup stage.” In one embodiment, the initialization module 220 stores the map data at setup stage in the map and routine data store 260 for rendering maps to the user upon a user request.

The map delivery module 230 is configured to receive requests for map data from the map clients 172 and provide map data responsive to those requests. Typically, a request for map data includes at least one endpoint location. The endpoint location may be a ‘favorite’ location, a location input by the user via an input mechanism provided by the map client 172, a location of a service provider (such as a taxi driver), or any other location specified by the map client 172. In response to such a request, the map delivery 240 retrieves the map data associated with the desired origin location from the map and routing data store 260 and transmits the map data to the map client 172. The map client 172 renders the stack of maps in the user interface based on the received map data.

In one embodiment, the map delivery module 230 may update the retrieved map data to render an interactive map about a current location of the user when the user requests maps for display. In another embodiment, the map delivery module 230 may send the map data for rendering an interactive map about the home of the user without any change to the map data if the interactive map is always determined to be about the home of the user based on the preset rule. In addition, the map delivery module 230 may also update the map data for rendering the interactive map responsive to detecting an update of the current location of the user. For example, if the interactive map corresponds with the current location of the user based on data from the client device, e.g., GPS co-ordinates, the map delivery module 230 updates the map data to reflect the change of the current location on the interactive map.

In some cases, the map client 172 also transmits a routing request to the routing module 240 for routing data in conjunction with the map data requested from the map delivery module 230. The routing request includes the desired location, the current location of the user, and, optionally, a desired origin location. Responsive to such requests, the routing module 240 is configured to access routing data stored in the map and routing data store 260 and identify a set of routing options for the endpoint location. A routing option identifies a series of transportation steps that a user may take to reach the endpoint location specified in the request. Alternatively, the routing option identifies a series of transportation steps that another user or entity may take to reach the current location or desired origin location from the endpoint location. In one embodiment, where an origin location is provided, each of the routing options identifies a different set of steps that may be taken to reach the endpoint location from the origin location. Alternatively, where an origin location is not provided, each of the routing options identifies a different set of steps that may be taken to reach the endpoint location from the current location of the user. A given routing option may be mixed-mode such that the routing options may include multiple different modes of transportation.

The routing data stored in the data store 260 includes public and private transportation schedules, such as bus, subway, and ferry schedules. The routing data also includes road and highway information, such as intersections, speed limits, traffic information, etc. In one embodiment, the transportation schedules are stored in the data store 260 in a data structure that represents the underlying timetables and allows for the efficient access of the data. The routing module 240 processes the routing data to compute the set of routing options for the endpoint location. In one embodiment, if more than a threshold number of routing options are available, the routing module 240 selects a subset of the available routing options. The selection may be based on the total travel time of the routing options, the cost of the routing options, the number of modes of transportation needed for the routing options, and preferences specified by the user that are stored in the user data 250.

The routing module 240 caches the set of routing options identified for the endpoint location such that future requests for the same or similar endpoint location from the same or similar origin location may be identified faster based on the cached routing options. The cached routing options may be stored in the map and routing data store 260 or, alternatively, may be stored in a cache structure internal to the routing module 240.

The routing module 240 also transmits the set of routing options to the map client 172 that transmitted the routing request. The rendering module 174 in the map client 172 presents the routing options to the user in the user interface. In one embodiment, only some of the routing options are presented in a main view and the remaining routing options are presented in a more detailed view. The rendering module 174 may also present an overlay of one or more of the routing options on the interactive map displayed in the user interface.

In one embodiment, the routing module 240 transmits routing options to the map client 172 as the routing options are identified. For example, the routing module 240 may quickly identify a bus routing option for the endpoint location. Without waiting to identify additional and, perhaps, more desirable routing options, the routing module 240 transmits the bus routing option to the map client 172 so that at least one routing option is presented to the user as fast as possible. In one embodiment, the routing module 240 determines the user's transportation preferences from the user data store 250 and first identifies the routing option that best matches the preferences. This routing option is then transmitted to the map client 172 before identifying other routing options.

### Example Processes for Instant Routing

Given that an interactive map allows a user of the map client 172 to navigate a map easily, it is important that routing options are similarly updated in a fast and fluid manner as the user navigates and explores the map. To that end, the map client 172 and the map server 110 operate in conjunction to provide “instant routing” as a user navigates an interactive map. With instant routing, as the user navigates a map, the routing options presented to the user also change in real-time depending on the new location to which the user has navigated. The changing routing options are presented automatically, in real-time, and without requiring an affirmative operation by the user. This experience advantageously provides quick response to the user's navigation and is frictionless with respect to the user's experience.

In operation, the interaction module 176 allows the user to specify a particular focal point overlaid on the interactive map. The point overlaid on the interactive map corresponds to the physical location represented by the interactive map at that point. In one embodiment, the focal point is always positioned at the center of the interactive map. In other embodiments, the focal point may be positioned where the user desires. In one embodiment, the interaction module 176 visually represents the focal point as a ‘pin’ on the interactive map. The pin may be a circular visual object overlaid on a location on the interactive map.

Once a user specifies a focal point on the interactive map, the interaction module 176 transmits a request to the routing module 240 for routing options between an origin location of the user and the physical location represented by the interactive map at the focal point from an origin location. The origin location may be a current location of the user or a different location associated with the interactive map (such as a favorite location, a frequently visited location, or a manually input location). As discussed above, the routing module 240 transmits a set of routing options responsive to such requests. The rendering module 174 displays these routing options to the user. In one embodiment, only a single routing option is presented in conjunction with the interactive map and other routing options are presented in a routing view. Further, the rendering module 174 may overlay the routing data associated with at least one of the routing options on the interactive map.

In one embodiment, the interaction module 176 also requests from the routing module 240 routing options between locations associated with any dynamic maps that are currently collapsed (and therefore not currently visible in their entirety) and the physical location represented by the interactive map at the focal point. The routing module 240 transmits a set of routing options responsive to such requests. The rendering module 174 displays at least one of these routing options to the user.

When the interaction module 176 receives a map panning interaction from the user on the interactive map, the interaction module 176 moves the underlying interactive map accordingly. The movement of the interactive map does not change the location of the focal point overlaid on the interactive map, and, therefore, the focal point corresponds to a new physical location represented by the interactive map at that point. In one embodiment, the interaction module 176 provides a visual indication on the focal point that a panning interaction is currently ongoing. For example, in the case where a pin is dropped on the interactive map, the interaction module 176 may change the color of the pin from the original color to a different color when the panning interaction begins and change the color back to the original color when the panning interaction ends. In another example, the interaction module 176 may elevate or change the shape of the pin when the panning interaction begins and reverse the changes when the panning interaction ends.

When the map panning interaction is complete, the interaction module 176 transmits a request to the routing module 240 for routing options between an origin location of the user and the new physical location represented by the interactive map at the focal point. Again, the origin location may be a current location of the user or a different location associated with the interactive map (such as a favorite location, a frequently visited location, or a manually input location). The routing module 240 transmits a set of routing options responsive to such requests. The rendering module 174 displays these routing options to the user. Importantly, the user does not perform any additional operation to update the routing options based on the new physical location represented by the focal point. In such a manner, the routing options are updated seamlessly and automatically without additional burdens placed on the user.

In one embodiment, as the panning interaction is ongoing, the interaction module 176 may transmit one or more anticipatory requests to the routing module 240 for routing options between an origin location and an estimated new physical location determined based on the panning interaction. Requesting such routing options before the user stops the panning interaction allows the interaction module 176 to have one or more routing options available immediately if the estimated new physical location is correct.

Also, in one embodiment, the interaction module 176 requests from the routing module 240 routing options between locations associated with any of the dynamic maps that are currently collapsed (and therefore not currently visible in their entirety) and the origin location. The routing module 240 transmits a set of routing options responsive to such requests. The rendering module 174 displays at least one of these routing options to the user. In such a manner, routing options between multiple endpoints and the origin location are computed and updated as the user interacts with the interactive map.

Specifically, in one embodiment, as the panning interaction is ongoing, the interaction module 176 simultaneously requests from the routing module 240 routing options between the locations associated with the collapsed dynamic maps, e.g., a “favorite” location or any other user-specified location, and the origin location. The origin location may be changing depending on manual input or by an automatically determined current location of the user. The routing module 240 determines routing options for each of the collapsed maps and transmits the routing options to the rendering module 174. In one embodiment, the rendering module 174 displays the routing options for a dynamic map only when the map is brought into view by the user.

In another embodiment, when a user selects an origin location and multiple endpoints, the interaction module 176 simultaneously requests from the routing module 240 routing options between the single origin location and the multiple endpoints. If the origin location changes, either via an explicit address provided by the user or via a panning operation, the interaction module 176 requests updated routing options from the new origin location to the multiple endpoints. Again, responsive to such requests, the routing module 240 determines routing options for each of the collapsed maps and transmits the routing options to the rendering module 174.

The routing module 240 is optimized for instant routing in two ways. First, the routing data, especially the transportation schedules, are stored in a compact data structure that allows for efficient access. Second, the routing module 240 caches previously computing routing options. Oftentimes, portions of previously identified routing options may be reused for the new physical location. In such scenarios, the routing module 240 computes only that portion of a routing option that is different for the new physical location. For example, assume the routing module has cached a routing option from an address in San Francisco to an address in Palo Alto requires the use of a Muni transit trolley within San Francisco, the Caltrain intercity train from San Francisco to Palo Alto and then a municipal transit bus from the Caltrain station to the address. When a request for a routing option from the same address in San Francisco to a different address in Palo Alto is received, the routing module 240 can reuse at least the Muni and Caltrain portions of the cached routing option and only has to compute the portion of the routing option that identifies the transportation step(s) from the Caltrain stop to the new address in Palo Alto.

FIG. 3 is a flowchart illustrating an example method 300 for providing routing options responsive to map panning interactions according to one embodiment. In one embodiment, FIG. 3 attributes the steps of the method 300 to the routing module 240 of the server 110. However, some or all of the steps may be performed by other entities such as the client devices 170. In addition, some embodiments may perform the steps in parallel, perform the steps in different orders, or perform different steps. Also, it is noted that in one example embodiment the steps and/or modules may be embodied as instructions that may be executed by the processor described below with respect to FIG. 7.

Initially, the routing module 240 determines 310 an origin location for the routing options. The origin location is the starting point for a routing option. The origin location may be a current location of a user, a location associated with the interactive map currently in view on the map client 172, or a location manually provided by a user. In one embodiment, the routing module 240 receives information related to the user and determines the origin location accordingly. In another embodiment, the routing module 240 receives the origin location from the map client 172 as a part of a routing request.

The routing module 240 also determines 320 an endpoint location for the routing options. The endpoint location corresponds to a focal point placed on an interactive map by a user. In one embodiment, the routing module 240 determines the endpoint location based on the position of the focal point and the physical area represented by the interactive map currently in view. In another embodiment, the routing module 240 receives the endpoint location from the map client 172 as a part of the routing request.

The routing module 240 then identifies 330 one or more routing options between the origin location and the endpoint location based on the routing data stored in the data store 260. The routing data includes transportation schedules and information related to roads, highways, bike paths, and pedestrian paths. The routing module 240 transmits 340 the one or more routing options to the map client 172 for display to the user. In some embodiments, only a subset of the routing options is displayed to the user in conjunction with the interactive map.

The routing module 240 then determines 350 that the user has manipulated the interactive map such that the focal point corresponds to a new endpoint location. As discussed above, the focal point does not move while the user pans the interactive map. Therefore, when the panning interaction is complete, the focal point corresponds to a new physical location represented by the interactive map at that point.

The routing module 240 updates 360 the one or more routing options based on the new endpoint location. In some embodiments, the routing module 240 may use portions of cached routing options (for example, the routing options transmitted to the map client 172) in the updated routing options for faster computation. The routing module 240 transmits 370 the one or more routing options to the map client 172 for display to the user. In some embodiments, only a subset of the routing options is displayed to the user in conjunction with the interactive map.

### Example User Interfaces

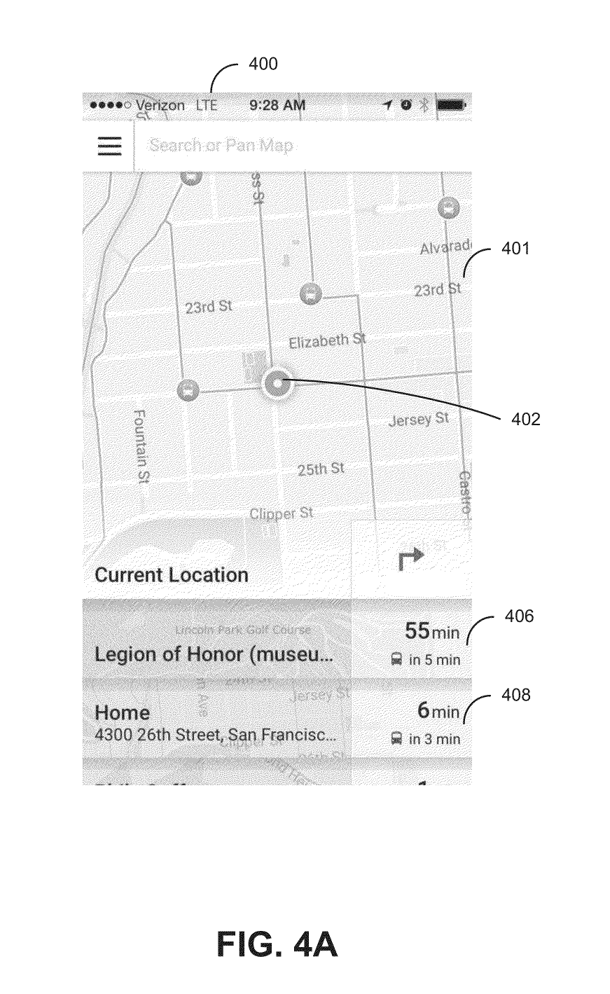

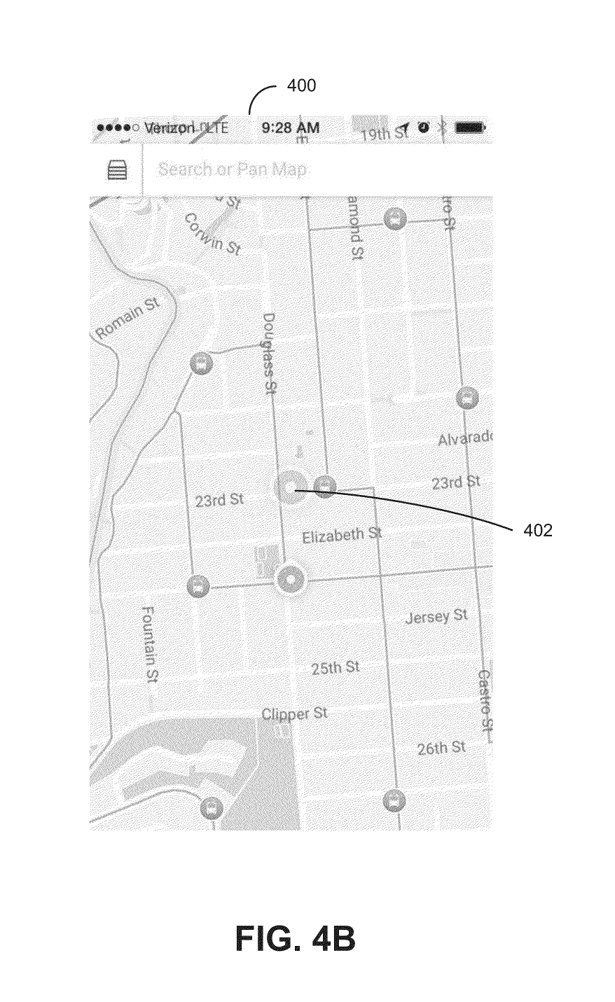

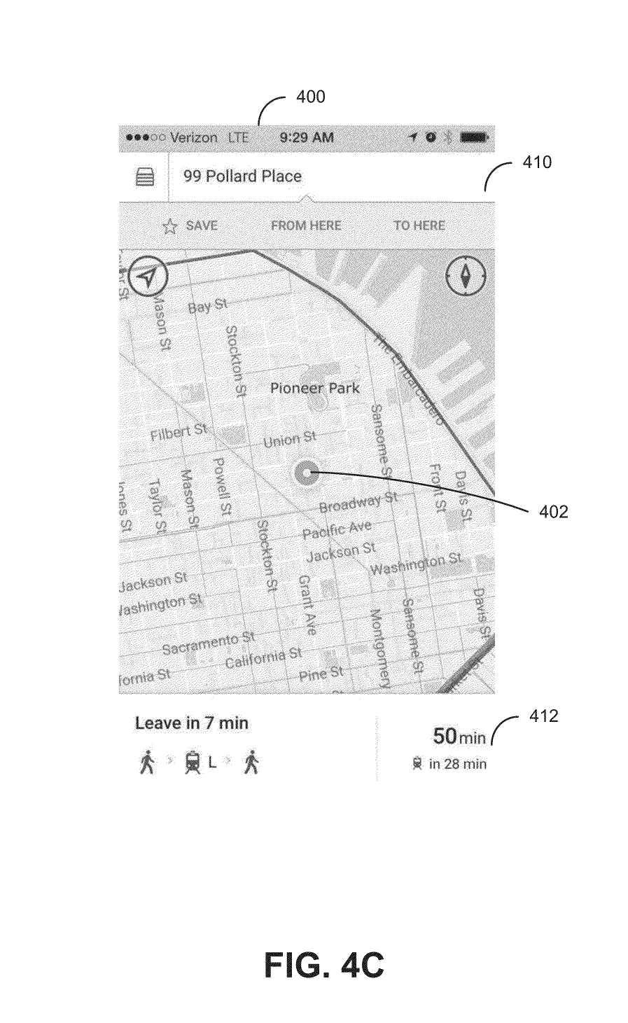

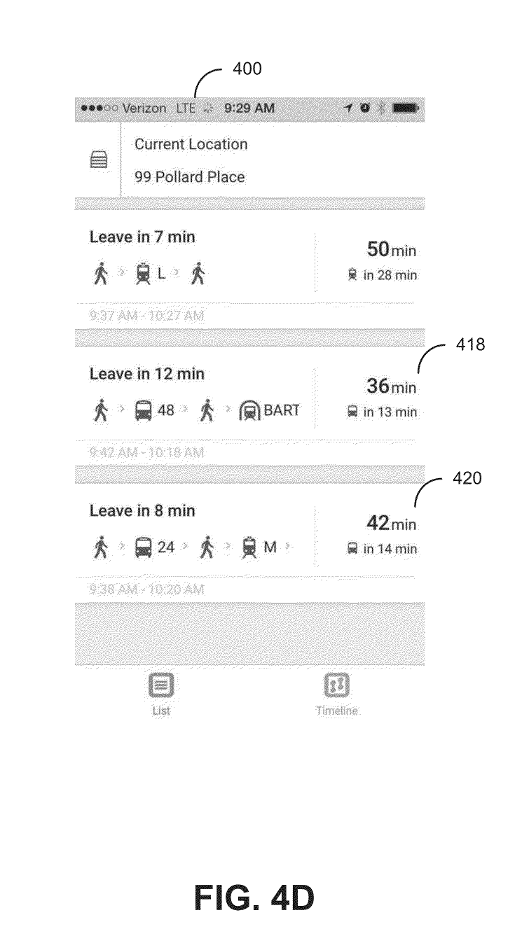

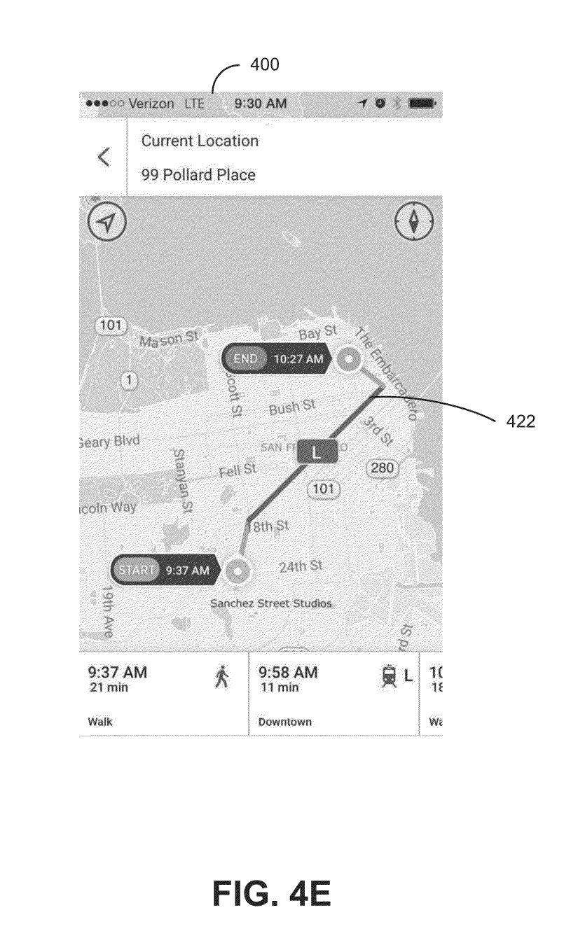

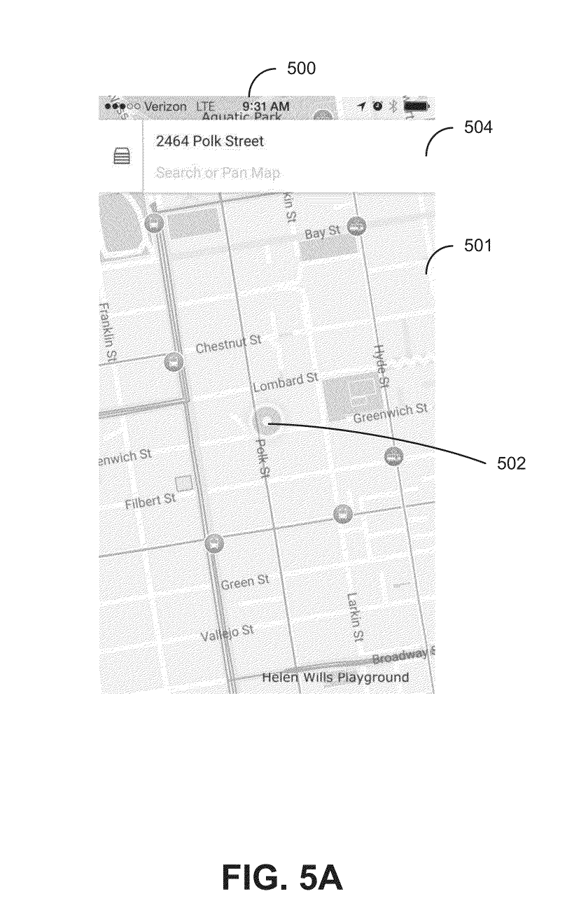

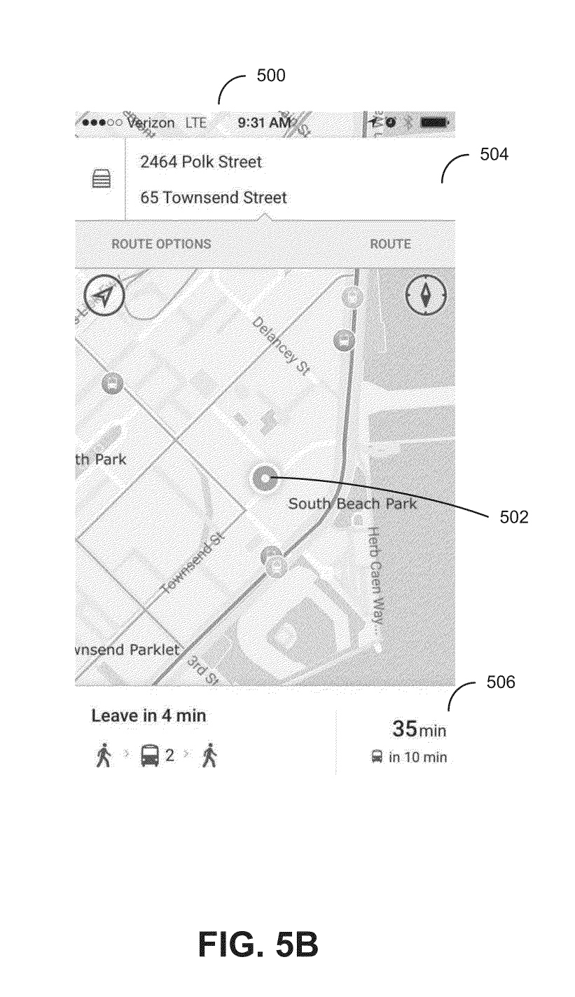

Referring now to FIGS. 4A-5B, illustrated are example graphical representations for user interfaces related to providing routing options to a user according to one embodiment. For example, the graphical user interfaces (GUIs) are generated by the map client 172 of the client device 170. It is noted that generation of the user interfaces is through program code that is stored in a storage device and executable by a processor of a client device 170. The instructions may be generated by the map server 110 or the client device 170 depending on where the particular modules described herein corresponding to the particular functions (and corresponding instructions) are executing.

FIG. 4A illustrates a GUI 400 showing a stack of maps. In the illustrated embodiment, the GUI 400 includes an interactive map 401 that has live data. As shown, the interactive map 401 includes a focal point 402 (referred to herein as the “pin 402”). A user may interact with the interactive map 401 in a variety of ways, including scrolling, panning, zooming, etc. In one embodiment, when interacting with the interactive map 401, the user drops the pin 402 on the interactive map 401.

The GUI 400 also includes a set of collapsed dynamic maps 406-408. Each of the set of collapsed dynamic maps 406-408 may be a screen shot (e.g., determined by the map module 115) describing a favorite location selected by the user. Each of the set of collapsed dynamic maps 406-408 may also include an estimated time and distance from the current location of the user and the predefined location described through the dynamic map. The set of collapsed dynamic maps 406-408 is displayed at the edge of the GUI 400 and can be scrolled by the user.

FIG. 4B illustrates the GUI 400 as the user begins a panning interaction with the interactive map 401. The interaction module 176 does not change the location of the static pin 402 overlaid on the interactive map as the panning interaction is ongoing. Therefore, the physical location represented by the static pin 402 overlaid on the map changes as the panning interaction is ongoing. Further, the static pin 402 in FIG. 4B is lighter in color than the static pin 402 in FIG. 4C. The interaction module 176 changes the visual appearance of the static pin 402 as the panning interaction is ongoing.

FIG. 4C illustrates the GUI 400 when the panning interaction with the interactive map 401 is complete. As shown, the static pin 402 represents a new physical location on the underlying interactive map. This GUI 400 displays the new physical location in the address box 410. In the example of FIG. 4C, the new physical location is “99 Pollard Place.” The GUI 400 also displays a routing option 412 that is instantly displayed when the panning interaction is complete. The routing option 412 identifies the transportation steps that the user would need to take from a current location to reach the physical location represented by the static pin 402. The routing option 412 also identifies an approximate time the journey would take and when the next available train is scheduled to depart.

FIG. 4D illustrates the GUI 400 displaying a routing option view. The routing option view includes additional routing options such as routing option 418 and routing option 420. As with routing option 412, these additional routing options identify the transportation steps that the user would take from a current location to reach the physical location represented by the static pin 402. The additional routing options also identify an approximate time the journey would take and when the next available bus is scheduled to depart. In one embodiment, the user of the GUI 400 drags up or taps on the routing option 412 in FIG. 4C to cause the routing option 412 to slide up with more additional routing options displayed underneath. This is the routing option view illustrated in FIG. 4D.

FIG. 4E illustrates the GUI 400 displaying the routing option 412 as an overlay 422 on the interactive map 401. The overlay 422 visually presents each of the transportation steps identified by the routing option 412 on the interactive map 401.

FIG. 5A illustrates the GUI 500 as the user begins a panning interaction with the interactive map 501. The address box 504 specifies an origin location for routing purposes. In one embodiment, the user manually enters the address of the origin location in the address box 504. In an alternate embodiment, the address box 504 is pre-populated with the address of the origin location determined based on an earlier interaction by the user with the GUI 500. As the panning interaction is ongoing, the interaction module 176 does not change the location of the static pin 502 on the interactive map. Therefore, the physical location represented by the static pin 502 changes as the panning interaction is ongoing.

FIG. 5B illustrates the GUI 500 when the panning interaction with the interactive map 501 is complete. As shown, the static pin 502 represents a new physical location on the underlying interactive map. This GUI 500 displays the new physical location in the address box 504. In the example of FIG. 5B, the new physical location is “65 Townsend Street.” The GUI 500 also includes a routing option 506 that is instantly displayed when the panning interaction is complete. The routing option 506 identifies the transportation steps that the user would need to take from the origin location to reach the physical location represented by the static pin 502. The routing option 506 also identifies an approximate time the journey would take and when the next available train is scheduled to depart.

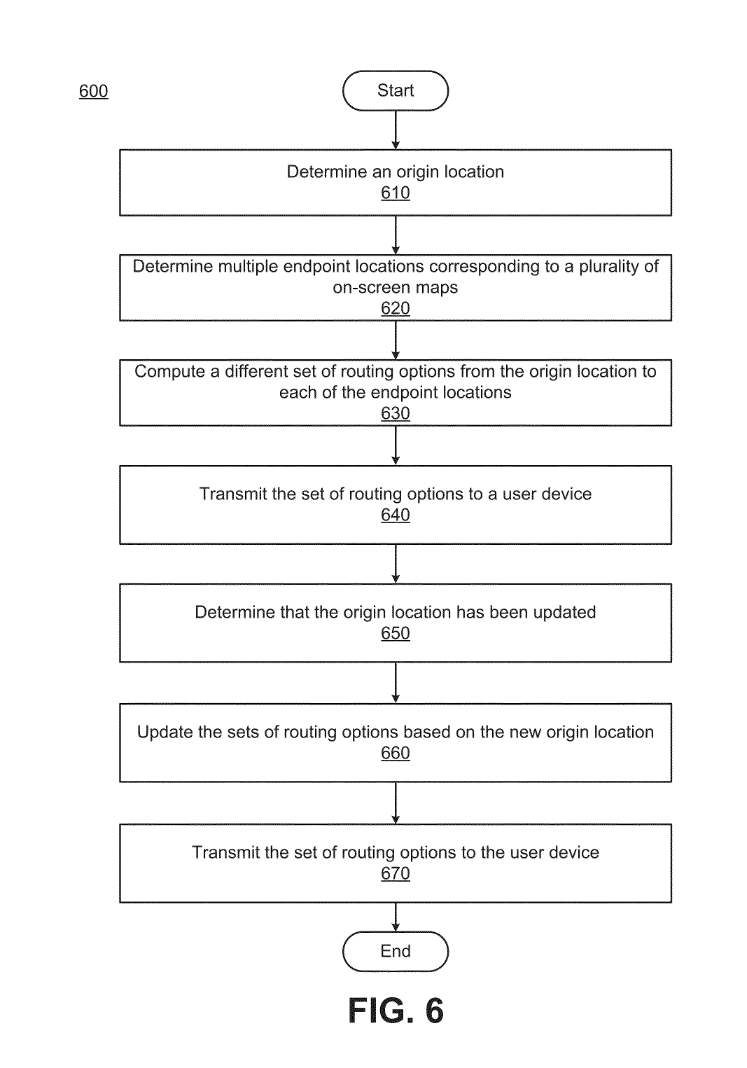

FIG. 6 is a flowchart illustrating an example method for simultaneously providing routing options for multiple endpoint locations according to one embodiment. In one embodiment, FIG. 6 attributes the steps of the method 600 to the routing module 240 of the server 110. However, some or all of the steps may be performed by other entities such as the client devices 170. In addition, some embodiments may perform the steps in parallel, perform the steps in different orders, or perform different steps. Also, it is noted that in one example embodiment the steps and/or modules may be embodied as instructions that may be executed by the processor described below with respect to FIG. 7.

Initially, the routing module 240 determines 610 an origin location for the routing options. The origin location is the starting point for a routing option. The origin location may be a current location of a user, a location associated with the interactive map currently in view on the map client 172, or a location manually provided by a user. In one embodiment, the routing module 240 receives information related to the user and determines the origin location accordingly. In another embodiment, the routing module 240 receives the origin location from the map client 172 as a part of a routing request.

The routing module 240 also determines 620 multiple endpoint locations each corresponding to a plurality of on-screen maps. At least one of the on-screen map is an interactive map currently in view and the remaining on-screen maps are dynamic maps that are currently collapsed. The endpoint locations associated with each of the dynamic maps may be a “favorite” location or any other user-specified location. In one embodiment, the endpoint location of the interactive map corresponds to a focal point placed on an interactive map by a user.

The routing module 240 then simultaneously computes 630 one or more routing options between the origin location and each of the multiple endpoint locations based on the routing data stored in the data store 260. The routing data includes transportation schedules and information related to roads, highways, bike paths, and pedestrian paths. The routing module 240 transmits 640 the one or more routing options to the map client 172 to a user device. In some embodiments, only a subset of the routing options is displayed to the user in conjunction with the interactive map.

The routing module 240 then determines 650 that the origin location has been updated. The origin location may be updated based on manual input by the end-user or automatically determined as a current location changes. The routing module 240 updates 660 the routing options based on the new endpoint location. In some embodiments, the routing module 240 may use portions of cached routing options (for example, the routing options transmitted to the map client 172) in the updated routing options for faster computation. The routing module 240 transmits 670 the one or more routing options to the map client 172 for display to the user device. In some embodiments, only a subset of the routing options is displayed to the user in conjunction with the interactive map.

### Computing Machine Architecture

Referring now to FIG. 7, it is a block diagram illustrating components of an example machine able to read instructions (e.g., software or program code) from a machine-readable medium and execute them in a processor (or controller). The example machine shows one or more components that may be structured, and operational, within a client device 170 and/or a server device 110. Specifically, FIG. 7 shows a diagrammatic representation of a machine in the example form of a computer system 700 within which instructions 724 (e.g., software or program code) for causing the machine to perform any one or more of the methodologies discussed herein may be executed. The methodologies can include the modules described with FIG. 1 and subsequently herein. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 724 (sequential or otherwise) that specify actions to be taken by that machine. Further, while only a single machine is illustrated, the term “machine” shall also be taken to include any collection of machines that individually or jointly execute instructions 724 to perform any one or more of the methodologies discussed herein.

The example computer system 700 includes one or more processors (generally processor 702) (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 704, and a dynamic memory 706, which are configured to communicate with each other via a bus 708. The computer system 700 may further include graphics display unit 710 (e.g., a plasma display panel (PDP), a liquid crystal display (LCD), a projector, or a cathode ray tube (CRT)). The computer system 700 may also include alphanumeric input device 712 (e.g., a keyboard), a cursor control device 714 (e.g., a mouse, a trackball, a joystick, a motion sensor, or other pointing instrument), a storage unit 716, a signal generation device 718 (e.g., a speaker), and a network interface device 670, which also are configured to communicate via the bus 708. In addition, the computer system 700 may include one or more positional sensors, e.g., an accelerometer or a global position system (GPS) sensor, connected with the bus 708. In addition, the network interface device 770 may include a WiFi or “cellular” mobile connection that also can be used to help identify locational information.

The storage unit 716 includes a machine-readable medium 722 on which are stored instructions 724 embodying any one or more of the methodologies or functions described herein. The instructions 724 may also reside, completely or at least partially, within the main memory 704 or within the processor 702 (e.g., within a processor's cache memory) during execution thereof by the computer system 700, the main memory 704 and the processor 702 also constituting machine-readable media. The instructions 724 (e.g., software) may be transmitted or received over a network 726 via the network interface device 670. It is noted that the database 130 can be stored in the storage 716 although it also can be stored in part or whole in the memory 704.

While machine-readable medium 722 is shown in an example embodiment to be a single medium, the term “machine-readable medium” should be taken to include a single medium or multiple media (e.g., a centralized or distributed database, or associated caches and servers) able to store instructions (e.g., instructions 724). The term “machine-readable medium” shall also be taken to include any medium that is capable of storing instructions (e.g., instructions 724) for execution by the machine and that cause the machine to perform any one or more of the methodologies disclosed herein. The term “machine-readable medium” includes, but not be limited to, data repositories in the form of solid-state memories, optical media, and magnetic media.

### Additional Configuration Considerations

Accordingly, as described above, the system and method for generating routing options for presentation to a user in response to panning interactions with digital maps. For example, the system can allow the user to select a particular position on the interactive map that remains static as the user pans the interactive map. When the panning interaction is complete, the static position corresponds to a different physical location relative to the original physical location. The system then provides routing options to the user from an origin location (either the current location or the manually input location) to the physical location corresponding to the static position.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms, e.g., as shown and described with FIGS. 1-5B. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors, e.g., processor 602) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software (or program code) to perform certain operations. It will be appreciated that the decision to implement a hardware module mechanically, in dedicated and permanently configured circuitry, or in temporarily configured circuitry (e.g., configured by software or program code) may be driven by cost and time considerations.

The various operations of example methods described herein may be performed, at least partially, by one or more processors, e.g., processor 602, that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The one or more processors may also operate to support performance of the relevant operations in a “cloud computing” environment or as a “software as a service” (SaaS). For example, at least some of the operations may be performed by a group of computers (as examples of machines including processors 602), these operations being accessible via a network (e.g., the Internet) and via one or more appropriate interfaces (e.g., application program interfaces (APIs).)

The performance of certain of the operations may be distributed among the one or more processors, e.g., processor 602, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process to provide instant routing when an interactive map is panned via a user interface. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer-implemented method for providing routing options to a user in real-time, the method comprising:
determining that a stack of geographic maps is visible in a user interface provided on a device, the stack of geographic maps including an interactive map that is in focus on the user interface and at least one collapsed map that is out of focus on the user interface;
for each map in the stack of geographic maps,
identifying an origin location and a plurality of endpoint locations associated with the map; and
simultaneously computing a set of routing options based on the origin location and a corresponding endpoint location, each of the routing options specifying a different series of steps needed to travel from the origin location to the corresponding endpoint location; and
providing the set of routing options corresponding to at least one endpoint location in the interactive map for display on the user interface.

2. A computer-implemented method for providing routing options to one or more users in real-time, the method comprising:
determining a plurality of endpoint locations associated with at least one on-screen map;
determining an origin location identifying a location associated with the user;
for each endpoint location, simultaneously computing a set of routing options based on the origin location and the endpoint location, each of the routing options specifying a different series of steps needed to travel from the origin location to the endpoint location or from the endpoint location to the origin location; and
providing the set of routing options for at least one of the endpoint locations for display to the user.

3. The method of claim 2, wherein determining the origin location comprise identifying the geographic coordinates of the origin location based on a selection of a focal point overlaid on a first on-screen map, the focal point configured to remain static as a user manipulates the first on-screen map.

4. The method of claim 2, further comprising determining that the origin location has changed and automatically computing, for each endpoint location, a different set of routing options based on the changed origin location and the endpoint location.

5. The method of claim 2, further comprising:
determining that a user is interacting with a first on-screen map to change the origin location;
estimating a different origin location from which the user would travel to the plurality of the endpoint locations based on interactions by the user with the first on-screen map; and
computing, for each endpoint location, a different set of routing options based on an estimated origin location and the endpoint location.

6. The method of claim 2, wherein at least one routing option between the origin location and a first endpoint location comprises a plurality of steps that each specifies a different mode of transportation for traveling at least a portion of a route between the origin location and the first endpoint location.

7. The method of claim 2, wherein, for each endpoint location, computing a set of routing options comprises determining a set of user settings provided by the user, and selecting routing options based on the set of user settings.

8. The method of claim 7, wherein a first user setting comprises one selected from a group consisting of a maximum number of transportation modes that may be present in a given routing option, one or more preferred types of transportation modes that may be present in a given routing option, a maximum number of transfers that may be present in a given routing option.

9. The method of claim 7, wherein a first user setting comprises a maximum cost that the user is willing to incur for any given routing option.

10. The method of claim 7, wherein a first user setting comprises a maximum desirable time that the user is willing to travel for any given routing option.

11. The method of claim 2, wherein the at least one on-screen map comprises a stack of geographic maps including an interactive map that is in focus on a user interface and at least one collapsed map that is out of focus on the user interface, each map in the stack of geographic maps associated with at least one endpoint location in the plurality of endpoint locations.

12. The method of claim 2, wherein providing the set of routing options comprises presenting in a main view a first routing option and the at least one on-screen map.

13. The method of claim 2, wherein providing the set of routing options comprises presenting in a routing option view each of the routing options in the set of routing options.

14. A computer-implemented method for providing routing options to a user in real-time, the method comprising:
receiving a selection of a focal point overlaid on an interactive map displayed to a user on a user interface, the focal point corresponding to a first location represented by the interactive map;
determining that the user has manipulated the interactive map such that the focal point corresponds to a second location represented by the interactive map;
computing a set of routing options based on an origin location and the second location, each of the routing options specifying a different series of steps needed to travel from the origin location to the second location; and
providing the set of routing options for display to the user.

15. The method of claim 14, wherein at least one routing option between the origin location and a first endpoint location comprises a plurality of steps that each specifies a different mode of transportation for traveling at least a portion of a route between the origin location and the first endpoint location.

16. The method of claim 14, wherein computing the set of routing options comprises determining a set of user settings provided by the user, and selecting routing options based on the set of user settings.

17. The method of claim 16, wherein a first user setting comprises one selected from a group consisting of a maximum number of transportation modes that may be present in a given routing option, one or more preferred types of transportation modes that may be present in a given routing option, a maximum number of transfers that may be present in a given routing option.

18. The method of claim 16, wherein a first user setting comprises a maximum cost that the user is willing to incur for any given routing option.

19. The method of claim 16, wherein a first user setting comprises a maximum desirable time that the user is willing to travel for any given routing option.

20. The method of claim 14, wherein the user interface includes the interactive map and at least one collapsed map that is out of focus on the user interface.
